(19) United States
(12) Patent Application Publication
(10) Pub. No.: US 2022/0399622 A1
(43) Pub. Date: Dec. 15, 2022

(54) BATTERY MODULE AND METHOD OF MANUFACTURING THE SAME

(71) Applicant: LG ENERGY SOLUTION, LTD., Seoul (KR)

(72) Inventors: Min Seop KIM, Daejeon (KR); Junyeob Seong, Daejeon (KR); Jongpil Jeon, Daejeon (KR)

(21) Appl. No.: 17/835,491

(22) Filed: Jun. 8, 2022

(30) Foreign Application Priority Data
Jun. 9, 2021 (KR) 10-2021-0074997

(51) Int. Cl. H01M 50/593; H01M 50/209; H01M 50/249; H01M 10/625; H01M 10/653

(52) U.S. Cl. CPC H01M 50/593; H01M 50/209; H01M 50/249; H01M 10/625; H01M 10/653; H01M 2220/20

(57) ABSTRACT

A battery module including a stack of a plurality of battery cells; a housing for the battery cell stack; and an insulating member located between the battery cell stack and the housing. The insulating member is continuously formed on a lower surface and two side surfaces of the battery cell stack.

### CROSS-REFERENCE TO RELATED APPLICATION

This application claims priority to and the benefit of Korean Patent Application No. 10-2021-0074997 filed in the Korean Intellectual Property Office on Jun. 9, 2021, the entire contents of which are incorporated herein by reference.

### TECHNICAL FIELD

The present disclosure relates to a battery module and a method of manufacturing the same, and more particularly, to a battery module which has improved assembly and insulation properties, and a method of manufacturing the same.

### BACKGROUND

Along with the development of technology and increasing demand for mobile devices, the demand for batteries as energy sources is increasing rapidly. In particular, a secondary battery has attracted considerable attention as an energy source for power-driven devices, such as an electric bicycle, an electric vehicle, and a hybrid electric vehicle, as well as an energy source for mobile devices, such as a mobile phone, a digital camera, a laptop computer and a wearable device.

Recently, along with an increasing demand for a large-capacity secondary battery structure, including the utilization of the secondary battery as an energy storage source, there is a growing demand for a battery module and a battery pack having a multi-module structure which is an assembly of battery modules in which a plurality of secondary batteries are connected in series or in parallel.

Meanwhile, when a plurality of battery cells are connected in series or in parallel to configure a battery pack, a method of configuring a battery module composed of at least one battery cell and then adding other components to the at least one battery module to configure a battery pack is common.

FIG. 1 is an exploded perspective view of a conventional battery module. FIG. 2 is an illustration of the assembled battery module of FIG. 1. FIG. 3 is an illustration of a pressure jig at the time of assembling a conventional battery module.

As illustrated in FIGS. 1 and 2, the conventional battery module 10 includes a battery cell stack 12 in which a plurality of battery cells 11 are stacked, and a housing 20 that houses the battery cell stack 12. The housing 20 may include a U-shaped housing 30 that covers the side surfaces and lower surface of the battery cell stack 12, and an upper plate 40 that covers the upper surface of the battery cell stack 12. Additionally, the battery module 10 includes end plates 15 that cover the front and rear surfaces of the battery cell stack 12, and a busbar frame 13 that may be formed between the battery cell stack 12 and the end plates 15. At this time, the battery cell stack 12 and the busbar frame 13 can be assembled to form a cell assembly.

As illustrated in FIG. 3, to assemble the conventional battery module 10, a plurality of battery cells 11 are first stacked to form a battery cell stack 12. Next, the battery cell stack 12 is pressed with a pressure jig 60 to weld electrode leads, thereby forming a cell assembly, and housing the cell assembly in the housing 20.

However, when the battery cell stack 12 itself is pressed with the pressure jig 60 to weld the electrode leads in this way and the cell assembly formed through the above process is housed in the housing, the possibility of deformation of the battery cell 11 and the battery cell stack 12 is large.

Further, the position of the electrode lead part before and after pressing is changed by pressing, which causes a problem whereby the position of the electrode lead part is not fixed.

Therefore, a structure capable of improving the assembly property and structural stability of a battery module and securing insulation property is needed by minimizing the possibility of deformation of the battery cell 11 and the battery cell stack 12 and allowing the position of the electrode lead part to be maintained even if it is pressed by a pressure jig 60.

### SUMMARY

It is an objective of the present disclosure to provide a battery module which has improved assembly and insulation properties, and a method of manufacturing the same.

The objectives of the present disclosure are not limited to the aforementioned objectives, and other objectives which are not described herein should be clearly understood by those skilled in the art from the following detailed description and the accompanying drawings.

According to one exemplary embodiment of the present disclosure, there is provided a battery module comprising: a battery cell stack in which a plurality of battery cells are stacked; a housing that houses the battery cell stack; and an insulating member located between the battery cell stack and the housing, wherein the insulating member continuously covers the lower part and both side parts of the battery cell stack.

The insulating member may be in contact with the bottom part of the housing.

The battery module further includes a thermal conductive resin layer located at the bottom part of the housing, wherein the thermal conductive resin layer may include a first thermal conductive resin layer and a second thermal conductive resin layer that are spaced apart from each other with respect to the insulating member portion in contact with the bottom part of the housing.

The insulating member may further include an extension part extending from both side parts of the battery cell stack and covering at least a part of an upper surface of the battery cell stack.

The battery module includes a frame member for covering the lower surface and both side surfaces of the battery cell stack, and an upper plate for covering the upper surface of the battery cell stack, and the extension part is located between the upper surface of the battery cell stack and the upper plate, and the insulating member may include a folding part formed at a portion where the extension part begins.

The insulating member includes a bottom part wrapping the lower surface of the battery cell stack, and side parts wrapping both side surfaces of the battery cell stack, and the bottom part and the side parts may be integrally formed.

The extension part may be integrally formed with the bottom part and the side parts.

A battery module according to one exemplary embodiment of the present disclosure may be configured such that a groove part is formed in the extension part.

According to another exemplary embodiment of the present disclosure, there is provided a method of manufacturing a battery module, the method comprising the steps of: stacking battery cells to form a battery cell stack; wrapping a lower surface and both side surfaces of the battery cell stack with an insulating member; welding electrode leads to the battery cells in a state in which the battery cell stack is wrapped with the insulating member, to form a cell assembly; and housing the cell assembly in a housing.

The insulating member may further include an extension part that extends from both side parts of the cell assembly.

The extension part may be formed with a handle for transporting the cell assembly, or may be formed with a connection part connected to a transport device.

After housing the cell assembly in the housing, the method may further include bending the extension part to be adjacent to an upper part of the cell assembly.

According to yet another exemplary embodiment of the present disclosure, there is provided a battery pack comprising the battery module.

The battery module according to exemplary embodiments of the present disclosure includes an insulating member that is pressed by a pressure jig and thus applies minimal pressure to the battery cell stack and the cell assembly, thereby minimizing the positional deformation of the electrode lead part and improving the assembly property and structural stability of the battery module.

The insulating member can be formed between the battery cell stack and the housing, thereby improving the insulating performance of the battery module.

Further, the battery cell stack and the cell assembly can be easily lifted by the insulating member, thereby enhancing the convenience of assembly.

However, the effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is an exploded perspective view of a conventional battery module;

FIG. 2 is an illustration of the assembled battery module of FIG. 1;

FIG. 3 is an illustration of a partial configuration and a pressure jig of a conventional battery module;

FIG. 4 is an exploded perspective view of a battery module according to an exemplary embodiment of the present disclosure;

FIG. 5 is an illustration of a cell assembly and an insulating member of a battery module according to an exemplary embodiment of the present disclosure;

FIG. 6 is an illustration of a cell assembly and an insulating member that are housed in a housing of a battery module according to an exemplary embodiment of the present disclosure;

FIG. 7 is an illustration of a cell assembly and an insulating member that are housed in a housing of a battery module according to another exemplary embodiment of the present disclosure;

FIG. 8 illustrates a partial configuration and a pressure jig of the battery module of the present disclosure; and

FIG. 9 illustrates a method of manufacturing a battery module according to another embodiment of the present disclosure.

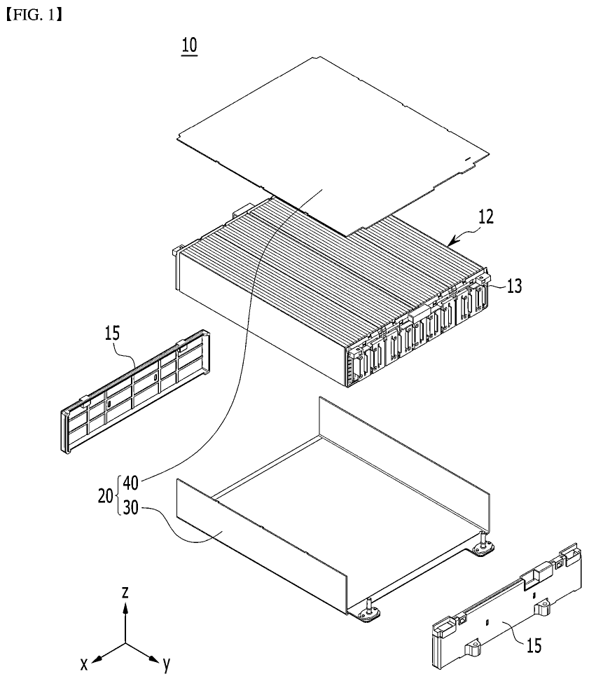

### DETAILED DESCRIPTION

Hereinafter, various embodiments of the present disclosure will be described in detail with reference to the accompanying drawings so that those skilled in the art can easily carry out them. The present disclosure may be modified in various different ways, and is not limited to the embodiments set forth herein.

A description of parts not related to the description will be omitted herein for clarity, and like reference numerals designate like elements throughout the description.

Further, in the drawings, the size and thickness of each element are arbitrarily illustrated for convenience of explanation, and the present disclosure is not necessarily limited to those illustrated in the drawings. In the drawings, the thickness of layers, regions, etc. are exaggerated for clarity. In the drawings, for convenience of description, the thicknesses of some layers and regions are exaggerated.

In addition, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, the word “on” or “above” means disposed on or below a reference portion, and does not necessarily mean being disposed “on” or “above” the reference portion toward the opposite direction of gravity.

Further, throughout the specification, when a portion is referred to as “including” a certain component, it means that the portion can further include other components, without excluding the other components, unless otherwise stated.

Further, throughout the specification, when referred to as “planar”, it means when a target portion is viewed from the upper side, and when referred to as “cross-sectional”, it means when a target portion is viewed from the side of a cross section cut vertically.

The terms “first,” “second,” etc. are used to explain various components, but the components should not be limited by the terms. These terms are only used to distinguish one component from the other component.

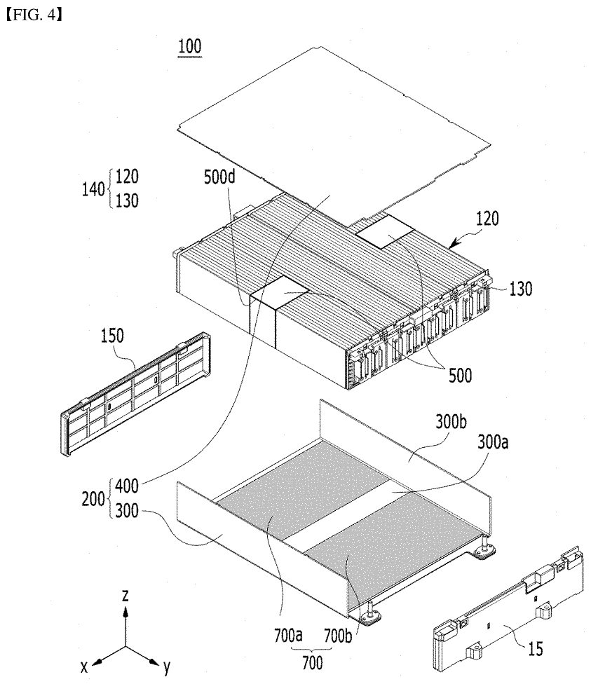

Now, a battery module including an insulating member according to an exemplary embodiment of the present disclosure will be described with reference to FIGS. 4 to 6 and 8.

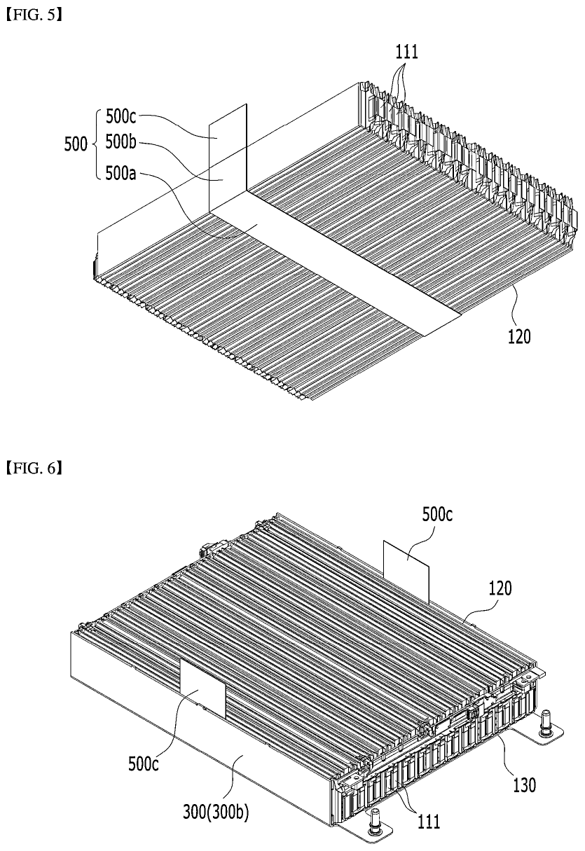

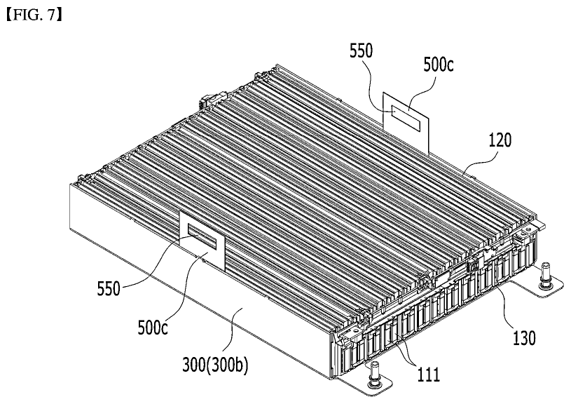

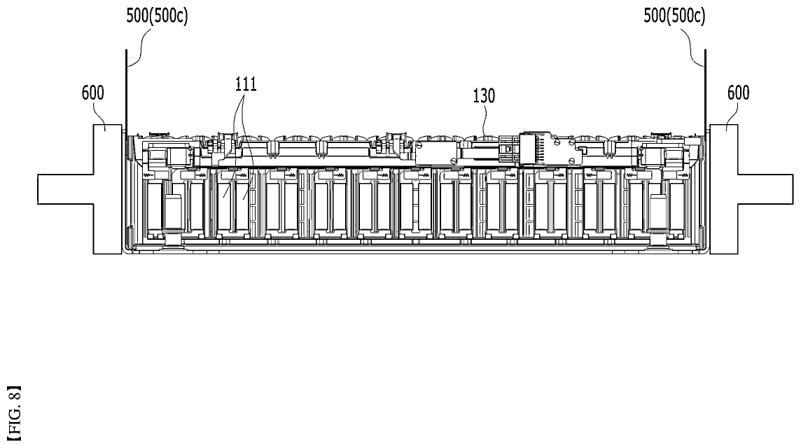

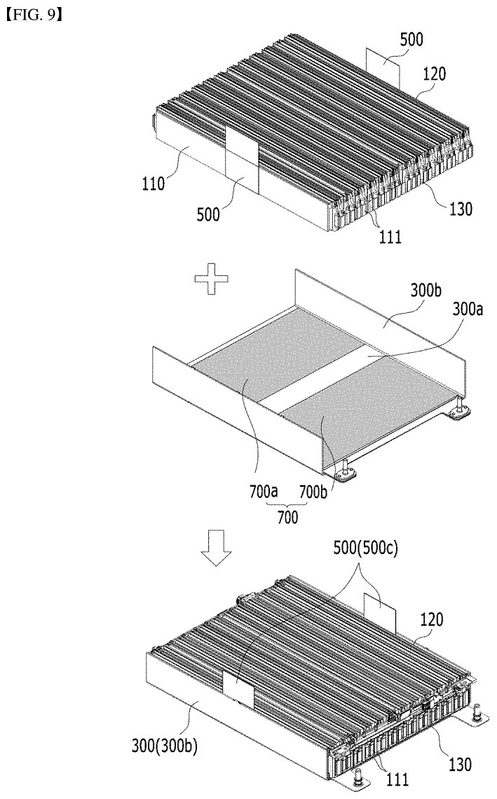

FIG. 4 is an exploded perspective view of a battery module according to an exemplary embodiment of the present disclosure. FIG. 5 is an illustration of a cell assembly and an insulating member of a battery module according to an exemplary embodiment of the present disclosure. FIG. 6 is an illustration of a cell assembly and an insulating member that are housed in a housing of a battery module according to an exemplary embodiment of the present disclosure. FIG. 8 illustrates a partial configuration and a pressure jig of the battery module of the present disclosure.

As illustrated in FIG. 4, a battery module 100 according to the present embodiment includes a battery cell stack 120 in which a plurality of battery cells 110 are stacked, a housing 200 that houses the battery cell stack 120, and end plates 150 for covering the front and rear surfaces of the battery cell stack 120. The battery module 100 further includes a busbar frame 130 located between each of the end plates 150 and the battery cell stack 120. The battery cell stack 120 and the busbar frame 130 may be combined to form the cell assembly 140.

The battery cell 110 is a secondary battery and can be configured as a pouch-type secondary battery. The battery cells 110 can be configured in plural numbers, and the plurality of battery cells can be stacked so as to be electrically connected to each other, thereby forming a battery cell stack 120 and forming a cell assembly 140 including a battery cell stack 120. The plurality of battery cells 110 may include an electrode assembly, a cell case, and an electrode lead 111 protruding from the electrode assembly.

The housing 200 includes a frame member 300 which has an open upper surface, front surface and rear surface and covers the lower surface and both side surfaces of the battery cell stack 120, and an upper plate 400 which covers an upper surface of the battery cell stack 120. However, the housing 200 is not limited thereto, and can be replaced with a frame having another shape such as an L-shaped frame or a mono-frame surrounding the battery cell stack 120 except the front and rear surfaces. The battery cell stack 120 housed inside the housing 200 can be physically protected via the housing 200. The frame member 300 may include a frame bottom part 300a for supporting the lower surface of the battery cell stack 120, and frame side parts 300b each extending upward from both ends of the frame bottom part 300a.

The upper plate 400 may cover the opened upper surface of the housing 200. The end plates 150 can cover the front and rear surfaces of the battery cell stack 120. The end plates 150 can be weld-coupled to the front and rear edges of the upper plate 400 and the front and rear edges of the housing 200.

A busbar frame 130 can be formed between each of the end plates 150 and the front and rear surfaces of the battery cell stack 120. A plurality of busbars mounted on the busbar frame 130 may protrude from the battery cells 110 to be in contact with the electrode leads 111 mounted on the busbar frame 130.

Additionally, the battery module 100 of the present disclosure may further include a thermal conductive resin layer 700 located at the bottom part of the housing 200, that is, at the bottom part of the frame 300a. As will be described later, the thermal conductive resin layer 700 may include a first thermal conductive resin layer 700a and a second thermal conductive resin layer 700b that are spaced apart from each other with respect to the insulating member 500 portion in contact with the frame bottom part 300a, which is the bottom part of the housing 200. Therefore, the insulating member 500 is formed between the thermal conductive resin layers 700 and can function as an insulating pad.

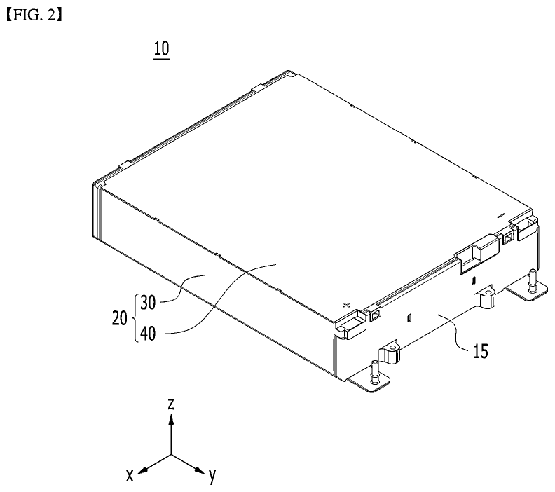

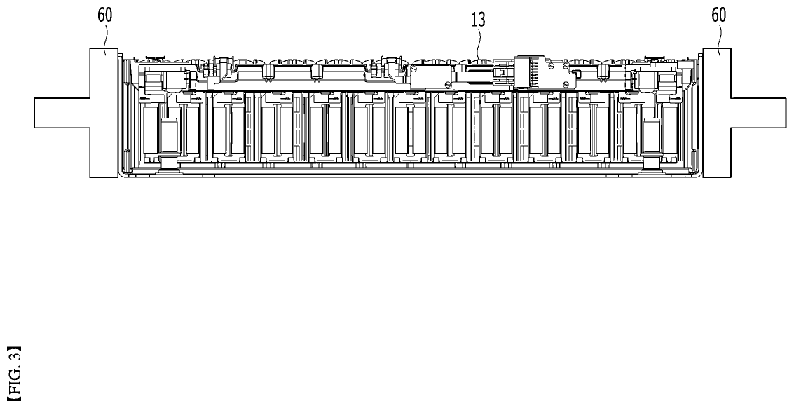

Additionally, according to an exemplary embodiment of the present disclosure, the battery module of FIG. 2 may be formed after the cell assembly 140 inserted into the housing 200 is covered with the upper plate 400.

Conventionally, after forming a battery cell stack, electrode leads are welded in a state in which the battery cell stack is pressed with a pressure jig, and a cell assembly formed by welding the electrode leads is housed in a housing. However, there was a problem that as the battery cell stack itself is pressed with the pressure jig, deformation of the battery cell and the battery cell stack occurs, and the position of the electrode lead part is not fixed. This is a problem caused by the battery cells being pressed toward the center of the battery cell stack by pressing the battery cell stack with the pressure jig, which requires a structure that can minimize the pressure applied to the battery cell stack.

Therefore, according to the present embodiment, the battery module includes an insulating member 500 located between the battery cell stack 120 and the housing 200, as shown in FIG. 4, to minimize the possibility of deformation of the battery cell stack 120 by the pressure jig 600 and fix the position of the electrode lead part. The insulating member 500 may continuously cover the lower surface and both side surfaces of the battery cell stack 120.

Therefore, the pressure jig 600 presses the insulating member 500 rather than the battery cell stack 120, and the electrode leads 111 proceed with welding and inserting processes, thereby minimizing the pressure applied to the battery cell stack 120. Thereby, the possibility of deformation of the battery cell stack 120 is minimized, and deformation of the position of the electrode lead part can be prevented. Further, by forming the insulating member 500 having insulating performance, the effect of improving the insulating properties of the battery cell stack 120 can be achieved.

Next, the insulating member formed in the battery module according to an exemplary embodiment of the present disclosure will be described in more detail.

As illustrated in FIGS. 5 and 6, the insulating member 500 may be in contact with the bottom part of the housing 200, and more specifically, it may be in contact with the frame bottom part 300a. Since the insulating member 500 continuously covers the lower surface and both side surfaces of the battery cell stack 120, it can come into contact with the frame bottom part 300a which is the bottom part of the housing 200 and the frame side part 300b which is a side surface part of the housing 200.

The insulating member 500 may wrap around a part or the whole of the lower surface and both side surfaces of the battery cell stack 120. Therefore, the insulating member 500 may be in contact with a part or the whole of the frame bottom part 300a which is the bottom part of the housing 200 and the frame side surface part 300b which is a side part of the housing 200.

The insulating member 500 may further include extension parts 500c extending from both side parts of the battery cell stack 120 and covering at least a part of the upper surface of the battery cell stack 120. Additionally, the insulating member 500 may include a bottom part 500a for wrapping the lower surface of the battery cell stack 120, and side surface portions 500b for wrapping both side surfaces of the battery cell stack 120. In particular, the bottom part 500a and the side surface parts 500b can be integrally formed, and the extension part 500c can also be integrally formed with the bottom part 500a and the side surface parts 500b.

The bottom part 500a of the insulating member 500 can serve to insulate between the battery cell stack 120 or the cell assembly 140 and the housing 200, and particularly may perform an insulating role between the battery cell stack 120, the cell assembly 140 and the frame bottom part 300a of the housing 200.

As illustrated in FIG. 8, the side parts 500b of the insulating member 500 can serve as a pressing part by the pressure jig 600. Therefore, the pressure jig 600 does not press the battery cell stack 120 and the cell assembly 140 itself, and the pressing by the pressure jig is minimized, whereby the battery cell 110 and the battery cell stack 120 are prevented from being deformed, and the position of the electrode lead part is fixed without being deformed. Additionally, the side parts 500b of the insulating member 500 serve to insulate between the battery cell stack 120 and the frame side surface part 300b of the housing 200, thereby achieving the effect of improving and enhancing the insulation performance of the battery module.

The extension part 500c of the insulating member 500 may serve as a lifting member capable of easily lifting the battery cell stack 120 and the cell assembly 140. Further, the extension part 500c is located between the upper surface of the battery cell stack 120 and the upper plate 400, and the insulating member 500 may include a folding part 500d formed at a portion where the extension portion 500c starts. The extension part 500c is bent to be in contact with the battery cell stack 120 and the upper plate 400 by the folding part 500d, and can be housed in the housing 200. Therefore, the extension part 500c can serve to insulate between the upper plate 400 of the housing 200 and the cell assembly 140.

As described above, the insulating member 500 includes a bottom part 500a, parts 500b, and an extension part 500c, thereby securing the insulating performance of the battery module and improving the assembly property. Further, the insulating member 500 may serve as a support when the cell assembly 140 is moved.

Next, a battery module including an insulating member according to another exemplary embodiment of the present disclosure will be described.

Since contents overlapping with the contents of the above-mentioned insulating member exist herein, only the contents different from those concerning the above-mentioned insulating member will be described.

FIG. 7 is an illustration of a cell assembly and an insulating member that are housed in a housing of a battery module including an insulating member according to another exemplary embodiment of the present disclosure.

As illustrated in FIG. 7, a groove part 550 may be formed in the extension part 500c of the insulating member 500. The groove part 550 may be formed to more easily lift the cell assembly 140. More specifically, the groove part 550 can function as a handle for lifting the cell assembly 140 or can be formed to be connected to an assembly device of a battery module, and can be used for various purposes within the range that can improve the assembly property of the battery module.

Next, a method of manufacturing a battery module according to another exemplary embodiment of the present disclosure will be described with reference to FIG. 9. Since there are contents that overlap with the above-mentioned battery module and the insulating member included in the battery module, the above contents will be omitted to avoid overlapping descriptions.

FIG. 9 illustrates a method of manufacturing a battery module according to another exemplary embodiment of the present disclosure.

As illustrated in FIG. 9, the battery cells 110 are stacked to form a battery cell stack 120, and the insulating member 500 may be formed to wrap around the lower surface and both side surfaces of the battery cell stack 120. That is, the lower surface and both side surfaces of the battery cell stack 120 may be wrapped with the insulating member 500. The insulating member 500 may wrap around a part or the whole of the lower surface and both side surfaces of the battery cell stack 120.

After forming the insulating member 500 that wraps around the battery cell stack 120 as described above, an electrode lead 111 can be welded to the battery cell 110 in a state where the battery cell stack 120 is wrapped with the insulating member 500, to form a cell assembly 140. Therefore, the possibility of position deformation of the electrode lead 111 and the electrode lead part can be minimized, and deformation of the battery cell stack 120 can also be minimized.

Further, after forming the cell assembly 140, the cell assembly 140 can be housed in the housing 200. At this time, the step of housing the cell assembly 140 in the housing 200 includes pressing the insulating member 500 for wrapping the cell assembly 140 with a pressure jig 600 and housing it in the housing 200.

In this case, the insulating member 500 may further include extension parts 500c formed by extending from both side surfaces of the battery cell stack 120. And, the extension portion 500c can be formed with a handle for transporting the cell assembly 140, or can be formed with a connection part connected to a transport device. The aforementioned groove part 550 may serve as the handle and the connection part.

Further, after housing the cell assembly 140 in the housing 200, the extension part 500c of the insulating member 500 can be bent to be in contact with the upper part of the cell assembly 140, and the extension part 500c can be housed in the housing 200. Therefore, the manufacturing method according to the present embodiment may include housing the cell assembly 140 in the housing 200, then bending the extension part 500c to be adjacent to the upper surface of the cell assembly 140, and housing the extension part 500c in the housing 200.

Subsequently, the method may include further assembling the end plates 150 for covering the front and rear surfaces of the cell assembly 140 and the upper plate 400 for covering the upper portion of the cell assembly 140. In this case, the assembly can be performed through welding, but is not limited thereto.

When the battery module is manufactured by the manufacturing method described above, the pressure jig 600 does not press the battery cell stack 120 and the cell assembly 140 itself, and thus the pressure by the pressure jig is minimized, thereby minimizing deformation of the battery cell 110 and the battery cell stack 120, and achieving the effect of fixing the position of the electrode lead portion without being deformed.

The above-mentioned battery module can be included in the battery pack. The battery pack may have a structure in which one or more of the battery modules according to the exemplary embodiments of the present disclosure are gathered, and packed together with a battery management system (BMS) and a cooling device that control and manage battery's temperature, voltage, etc.

The above-mentioned battery pack can be applied to various devices. Such a device may be applied to a vehicle means such as an electric bicycle, an electric vehicle, or a hybrid vehicle, but the present disclosure is not limited thereto, and is applicable to various devices that can use a battery module, which also falls under the scope of the present disclosure.

Although the invention has been shown and described with reference to the preferred embodiments, the scope of the present disclosure is not limited thereto, and numerous other modifications and embodiments can be devised by those skilled in the art, without departing from the spirit and scope of the principles of the invention described in the appended claims. Further, these modified embodiments should not be understood individually from the technical spirit or perspective of the present disclosure.

1. A battery module comprising:
a battery cell stack comprising a plurality of battery cells;
a housing comprising the battery cell stack; and
an insulating member located between the battery cell stack and the housing,
wherein the insulating member is continuously formed on a lower surface and two side surfaces of the battery cell stack.

2. The battery module of claim 1, wherein:
a bottom part of the insulating member is in contact with a bottom part of the housing.

3. The battery module of claim 2, further comprising:
a thermal conductive resin layer located on the bottom part of the housing,
wherein the thermal conductive resin layer comprises a first thermal conductive resin layer and a second thermal conductive resin layer separated by the bottom part of the insulating member.

4. The battery module of claim 1, wherein:
the insulating member further comprises an extension part extending from the two side surfaces of the battery cell stack and covering at least a portion of an upper surface of the battery cell stack.

5. The battery module of claim 4, wherein:
the housing comprises a frame member for covering the lower surface and the two side surfaces of the battery cell stack, and an upper plate for covering the upper surface of the battery cell stack,
the extension part is located between the upper surface of the battery cell stack and the upper plate, and
the insulating member further comprises a folding part formed at a position where two side parts of the insulating member covering each of the two side surfaces of the battery cell stack, respectively, meets the extension part covering at least the part of the upper surface.

6. The battery module of claim 4, wherein:
the bottom part of the insulating member is in contact with the lower surface of the battery cell stack, and the two side parts of the insulating member are in contact with each of the two side surfaces of the battery cell stack, respectively, and
the bottom part and the two side parts of the insulating member are integrally formed.

7. The battery module of claim 6, wherein:
the extension part is integrally formed with the bottom part and the two side parts of the insulating member.

8. The battery module of claim 4, wherein:
the extension part comprises a groove.

9. A method of manufacturing a battery module, the method comprising the steps of:
stacking a plurality of battery cells to form a battery cell stack;
contacting a lower surface and two side surfaces of the battery cell stack with a bottom part and two side parts of an insulating member, respectively;
welding electrode leads to the plurality of battery cells after the battery cell stack is contacted with the insulating member to form a cell assembly; and
placing the cell assembly in a housing.

10. The method of claim 9, wherein:
the insulating member further comprises an extension part extending from the two side parts of the insulating member.

11. The method of claim 10, wherein:
the extension part comprises a handle for transporting the cell assembly.

12. The method of claim 11, further comprising:
bending the extension part to as to be adjacent to a portion of an upper surface of the battery cell stack after placing the cell assembly in the housing.

13. A battery pack comprising the battery module of claim 1.

14. The method of claim 10, wherein:
the extension part comprises a connection part connected to a transport device.

15. The method of claim 14, further comprising:
bending the extension part to be adjacent to a portion of an upper surface of the battery cell stack after placing the cell assembly in the housing.
